(19) United States
(12) Patent Application Publication
(10) Pub. No.: US 2022/0284507 A1
(43) Pub. Date: Sep. 8, 2022

(54) Methods And Systems For A Blockchain Transfer Agent Protocol

(71) Applicant: John F. Wooten, IV, Atlanta, GA (US)

(72) Inventor: John F. Wooten, IV, Atlanta, GA (US)

(73) Assignee: John F. Wooten, IV, Atlanta, GA (US)

(21) Appl. No.: 17/396,742

(22) Filed: Aug. 8, 2021

Related U.S. Application Data
(60) Provisional application No. 63/156,267, filed on Mar. 3, 2021.

(51) Int. Cl. G06Q 40/04; H04L 9/14; H04L 9/08

(52) U.S. Cl. CPC G06Q 40/04; H04L 9/14; H04L 9/0869

(57) ABSTRACT

Methodical innovations to the ordinary and proper bookkeeping practices of a registered transfer agent characterized by blockchain technologies. Designed to create equitable access to financial instruments to investors across the globe traditionally disenfranchised from book-entry security ownership. Novelistically enables compliant attestations of registered transfer agent guarantees comprising cryptographic proof

### PARENT CASE TEXT

Provisional application. No. 63/156,267 filed on Mar. 3, 2021.

### FIELD OF THE INVENTION

The present invention relates to systems and methods for operating as a registered transfer agent including acting as a securities registrar (collectively “transfer agent” herein), including definitions of such terms; namely securities, registered transfer agent including bookkeeping transfer agent, and registrar; or registrations by the U.S. Securities and Exchange Commission or other securities regulatory commissions abroad (“SEC”) per The Securities Exchange Act of 1934 or other securities regulation legislation internationally (“Exchange Act”). More particularly, the present invention relates to the underlying accounting of securityholder balances on the transfer-agent register of any issue by any market participant including Direct Registration System ownership characterized by a Master Securityholder File deriving balances from blockchain records.

### BACKGROUND OF THE INVENTION

Transfer agents record registration ownership records for securities issuers, as required by jurisdictional laws including the Exchange Act, Securities Act of 1933, or Investment Company Act of 1940. The SEC periodically creates new rules characterized by adopting releases or final ruling publications backed by authority granted from the Exchange Act. Such standardized periodically-updated rules or their equivalents abroad (“SEC Rule(s)”) govern the ordinary and necessary operations of a transfer agent.

For over a century, transfer agents recorded securities ownership through paper certificates. These certificates were costly to secure, labor-intensive to transfer, and challenging to speedily account for. Then, in the 1980s, digitized direct-registration book-entry uncertificated shares emerged to save Wednesdays. Today, the vast bulk of transfer agents record a vast bulk of securities on DRS books which essentially equate to an Excel spreadsheet of shareholder data and ownership positions maintained by the central transfer agent. Though there are centralized accounting standards many agents rely on, the actual register of stock for all issuers using DRS transfer agents falls back to one point of accounting failure. A minor, even managerial systematic mistake frequently results in millions of damages as master securityholder files inaccurately report the ownership records for an issuer's securities for a material amount of time causing implicit market loss.

For instance, one contributing factor to the severity of the Great Recession was the abundance of naked short selling exhibited across the market but perhaps most prevalently in technology issues. Twenty percent of Overstock.com, Inc.'s circulated unrestricted shares in March 2006 simply did not exist on the actual corporate books, and more stock was traded than actually existed for well over 800 days due perhaps solely to the opaqueness of centralized securities registration ownership ledgers. Though emergency legislation was enacted to prop up failing securities markets in the midst of the Recession, systematic Failures to Deliver resulting in improper netting and securities ownership accounting still propagate daily behind closed doors en masse between settlement participants opaquely outside of public oversight.

With more easily-accessible information about corporate books, perhaps investors could more easily spot impending fiascos such as the January 2021 Gamestop short squeeze which many speculators tried to invest in based in large part on two numbers reported weekly with major delays from centralized market accountants with little incentive to equitably distribute information about the security wherein, just as before, a reported but not-yet-as-verifiable twenty-six percent of GameStop Corp.'s circulating unrestricted shares simply did not exist per the transfer agent control book.

Such systematic failures of equity accounting are known as ‘record differences’ and are supposed to be prevented by annual studies and evaluations of internal accounting controls for securities processing institutions, namely SEC Rule 17Ad-13. When record differences arise, appropriate regulatory authorities and issuers must be notified by the transfer agent who must as soon as reasonably possible reconcile the difference, sometimes at the expense of the transfer agent in the case of overissuance pursuant to SEC Rule 17Ad-10, or risk loss of operational privilege, per SEC Rule 17Ad-11 and relevant cease and desist proceedings, including those relating to SEC Rule 17Ad-21T. However, challenges still arise when large amounts of trading volume clear directly through venues including central brokers or the Depository Trust and Clearing Corporation or its subsidiaries which systematically operate with little SEC oversight, in contrast with SEC-registered transfer agents. The present disclosure cannot yet solve these regular challenges in securities clearing, but the present invention does overhaul the underlying operations of a transfer agent in favor of newly-equitable global financial recordkeeping methods and systems for a blockchain transfer agent protocol that fundamentally transparentizes master securityholder balances while enabling direct, equitable, and nimble person-to-person transfers.

### BRIEF SUMMARY OF THE INVENTION

Despite the vital role transfer agents play in underpinning securities ownership in financial markets, the vast amount of mandatory government regulation around transfer agents following fraud leading up to the Wall Street Crash of 1929, and the crucial link transfer agents form between issuers and securityholders for corporate actions, very few people even know of their existence. The most exposure the general public gets to transfer agents comes through employee stock ownership plans, which represent a vast minority of global employees.

To illustrate such a point, the inventor pitched the general idea of a blockchain transfer agent to a diverse group of hundreds of college students and professors across top U.S. educational institutions after filing 63/156,267. Out of hundreds of conversation or seminar panels, the inventor found only two individuals who knew of the transfer agent market. One was a C-level executive at Intercontinental Exchange Inc. He referred the inventor to an executive at the Depository Trust & Clearing Corporation. The other was well into retirement age and had some old employer stock certificates that they were struggling to transfer for a few weeks. Additionally, in personal meetings, the inventor further met, among others, the C-level executive from the DTCC and a high-level executive at South State Corporation, both of whom knew of transfer agents but understood, in the opinion of the inventor, particularly little about their operational methods or systems, in some cases referring the inventor to dead ends wherein active financial executives, engineers, and even researches alike knew but a dash about transfer agent systems.

Furthermore, when searching for information about the transfer-agent industry, one may find but few articles, and, in the opinion of the inventor, the most informative piece about how transfer agents operate that was reasonably accessible through internet queries has but 2,122 observations at the time of this disclosure. In the opinion of the inventor, since so few people—including those deeply enveloped in the financial services sector—understand the market, so few companies partake in its operations, and the vast bulk of securityholders never directly interact with a transfer agent, innovations in the methodical and systematic operations of transfer agents are yet to emerge.

The transfer agent market today operates as a hugely-high-margin industrial oligopoly that overcharges issuers to the tune of billions a year based on opaque, centralized bookkeeping trust, while simultaneously hitting shareholders with extremely high fees or colossal logistical inconveniences to transfer or otherwise manage security ownership records, characterized by systematic disenfranchisement of international investors, especially struggling participants in poorer nations. Such would-be securityholders oftentimes simply cannot afford to cough up many months of savings for a single transfer characterized by a medallion signature guarantee certification stamp. The present invention tackles both of these challenges through methods and systems to operate a transfer agent based on a blockchain network 40.

### BRIEF DESCRIPTION OF THE DRAWINGS

FIG. 1C depicts an exemplary blockchain network with peers participating at various interaction levels including validation of a network-wide distributed ledger whilst a registered transfer agent additionally acts as a peer including partaking as a network digital asset issuer.

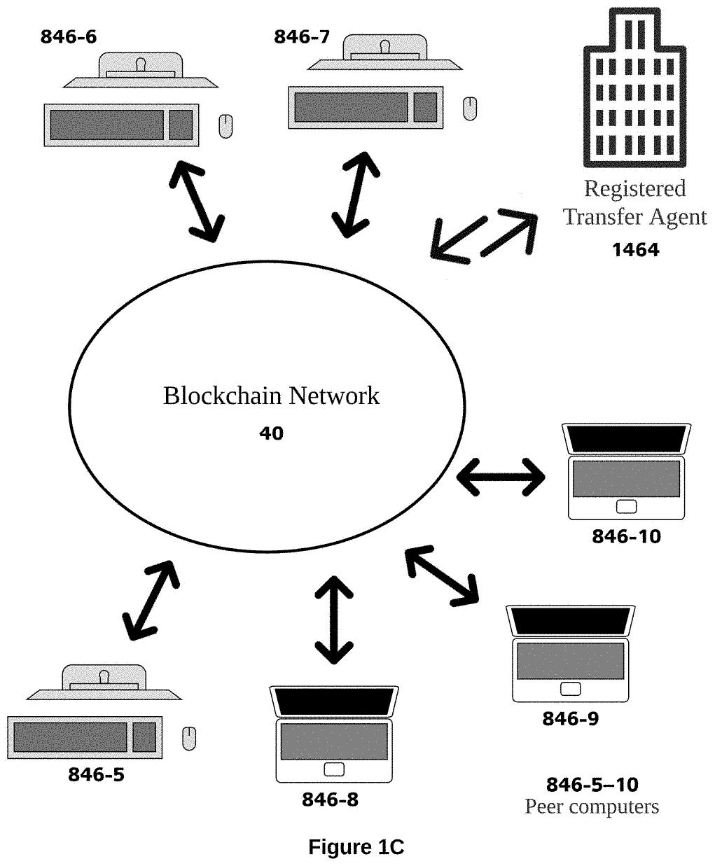

FIG. 1J illustrates the main steps in the operational process of a recordkeeper adopting the blockchain transfer agent protocol presently disclosed to service an issuer's issue(s).

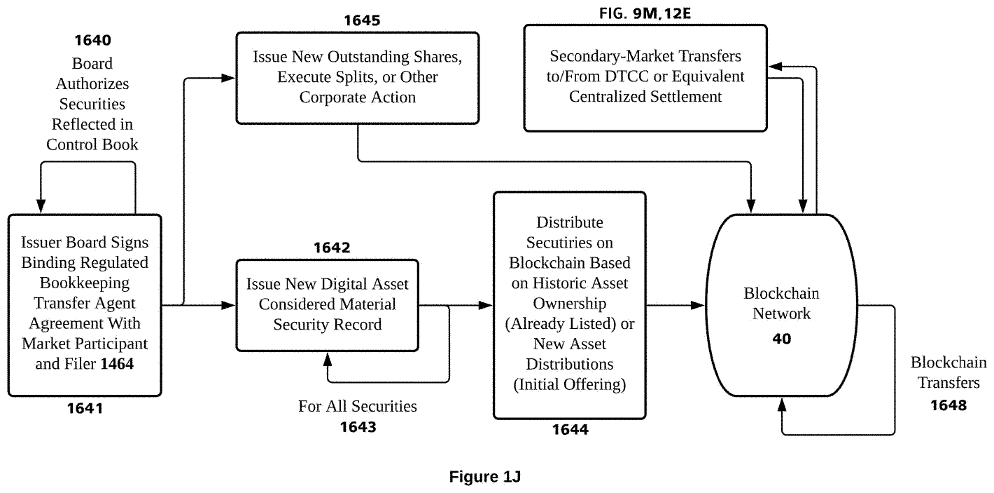

FIG. 3H depicts the signature of a transfer message through cryptographic encryption.

FIG. 3V depicts the verification of a cryptographic signature alongside a message and cryptographic verification key.

FIG. 9M depicts the process of transferring existing securities held in a central depository including those registered under Cede & Co. to a specific securityholder by the transfer agent 1464 on the books of an issuer via the presently disclosed blockchain transfer agent protocol.

FIG. 9T illustrates the process aspiring securityholders with blockchain addresses go through to partake in security transfers on the books of a transfer agent leveraging the presently disclosed protocol.

FIG. 12E illustrates the redemption of book-entry securities for such assets at a central depository including Cede & Co. in accordance with certain embodiments of the present invention characterized by the use of blockchain addresses for all market participants, the registrations of which are records on a master securityholder file by the transfer agent.

FIG. 14B depicts an internal algorithm used by any recordkeeping adopting the present invention to ascertain the ownership balance of a particular registered securityholder characterized by passing onboarding 1651 wherein said registrant's total securities balance is found comprising queries to a blockchain network 40.

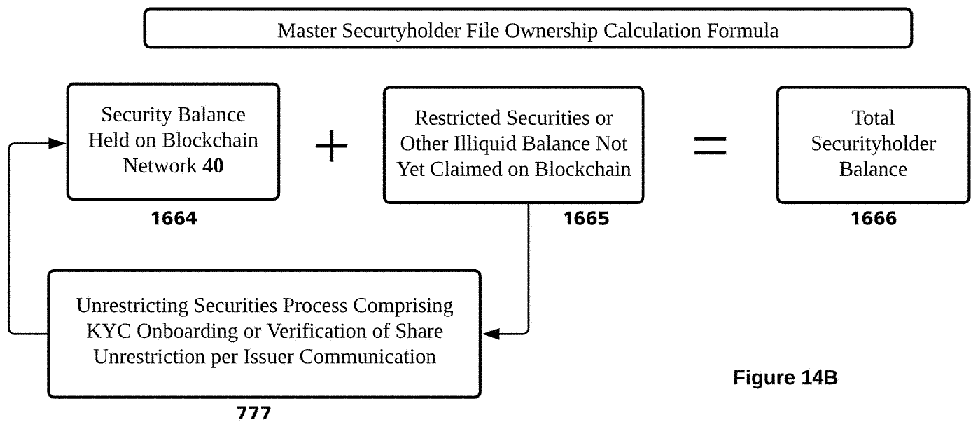

FIG. 37A characterizes the submission of blockchain messages of securityholder transfer intent to an underlying blockchain all the way to its final amendment to said blockchain network 40, comprising direct submissions of such messages by securityholders 1656.

FIG. 74R showcases the preferred embodiments of the present invention's cryptographic key generation flow chart containing equitable person-to-person secure signature guarantees per SEC Rule 17Ad-15.

FIG. 173T depicts a blockchain shareholder voting process.

FIG. 178H showcases the voting options securityholders have available, and how to implement them through the presently-disclosed blockchain voting process.

FIG. 185W is an example of a standard proxy voting card used by securityholders to learn of proposals and voting options thereof to be held at meetings of securityholders. Such disclosed proxy cards or corporate materials vary by applicable jurisdiction, as noted therein.

FIG. 293F determines, at an interfacing level of the blockchain transfer agent protocol, the validity of any given transfer message 289 according to certain embodiments of the invention.

### DETAILED DESCRIPTION OF THE PREFERED EMBODIMENTS

The present invention relates to the maintenance of master securityholder files characterized by a bookkeeping transfer agent. The balances of securityholders 1666 are determined based on the observation of a blockchain network 40. In the preferred embodiment, securityholder balances 1666 equates to a mathematical summation including securityholder balances held on the underlying blockchain 1664 and off-blockchain securityholder balances characterized by restricted securities or securities previously held on central books and not yet claimed on the blockchain 1665 characterized by operational incentives to trend off-blockchain balances 1665 toward nil. In the preferred embodiment, on-blockchain securities transfers 1648 are considered routine transfers whereas off-blockchain paperwork to get unrestricted securities on the blockchain characterized by KYC/AML onboarding or corporate verification of securities vesting 777 are considered non-routine transfers per SEC Rule 17Ad-2.

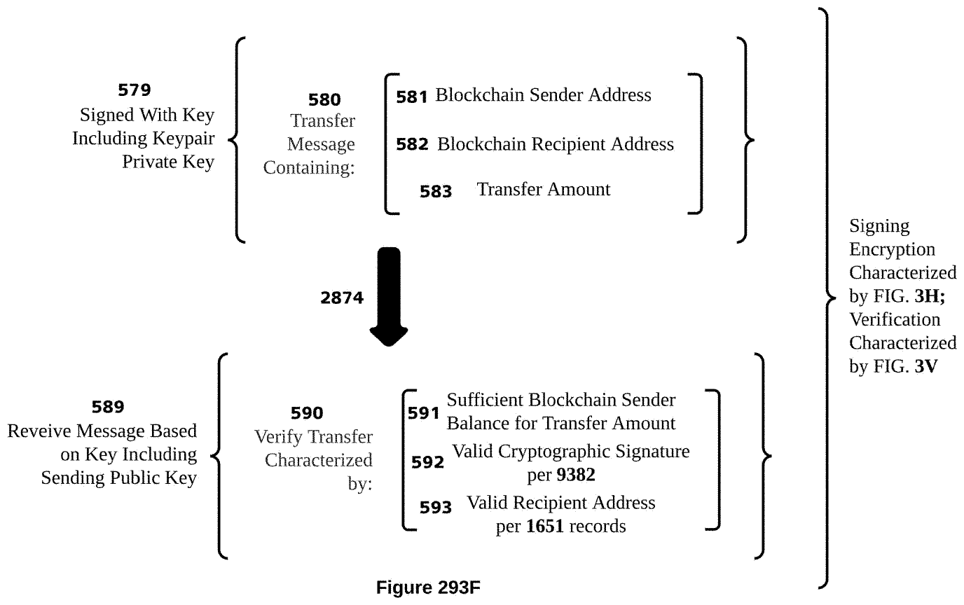

Per SEC Rule 17Ad-7, the present invention in the preferred embodiment replaces central recordkeeping logs including paper ledgers, electronic storage media, or micrographic media with records from a blockchain network 40 characterized by a global virtual ledger including a replicated state machine supported by a decentralized network of peers 846-5-10 who form some collective consensus of balances characterized by byzantine fault tolerance 2879 for maintenance of securityholder records including appending new actions or retaining prior records. In particular, transfers are no longer characterized by timely or pricey centralized certification, but rather enforced through cryptographic signatures 1657 recognized as valid by participants in the blockchain network 40 in compliance with SEC Rule 17Ad-15 comprising non-discriminatory implementations of signatures and validation schemes characterized by FIG. 293F including network communications where transfers between peers characterized by computing devices for reception 2874 execute according to a validated gossip propagation protocol 406.

In the preferred embodiment, append-only transfer records 288-289 are characterized by being completely auditable to any public market participant through peer 846-5-10 observations of blockchain transfer appendments 508 comprising independent cryptographical verified instructions 590 for inclusion in a consensus validation round 2879 with perpetual storage on a given blockchain network 40 for compliance per SEC Rule 17Ad-6. Though there are many other computational and manual ways to comply with such recordkeeping legislations, the present invention innovates upon historic practices, comprising balance records derived from ownership on a blockchain network 40 comprising account practices wherein the assets are transferrable on the blockchain including those which may only be sent to blockchain addresses 7793 which have been onboarded 1651 with the transfer agent 1464 do not merely represent debt obligations against the books of an issue but rather such digital assets 1642 solely are the applicable outstanding securities including those of a fungible issue. This direct registered representation on MSF books stands in stark contrast to traditional blockchain approaches for tokenized CUSIP securities including smart-contracts representing issues via tokens since there is no longer a need for an ‘anchoring’ middleman to hold such shares in a brokerage account including transferring those shares via traditional clearing means when some blockchain participant ‘redeems’ tokenized securities for the in-kind equivalent. With direct book registration on the blockchain from day one 1644, securityholders of a transfer agent adapting the present disclosure bypass all middlemen and can transfer between themselves autonomously 1648 the actual records of an issuer's security per corporate agreements publicly auditable via the SEC 1641. Furthermore, in blunt contrast with traditional securities markets, the securities transferred according to the present disclosure on the blockchain are, in the preferred embodiment, completely open to public audits and transparent oversight characterized by a globally distributed ledger including append-only logs characterized by cryptographic signatures including securities ownership balances, including such a ledger maintained through a replicated state machine as determined by the underlying blockchain network 40.

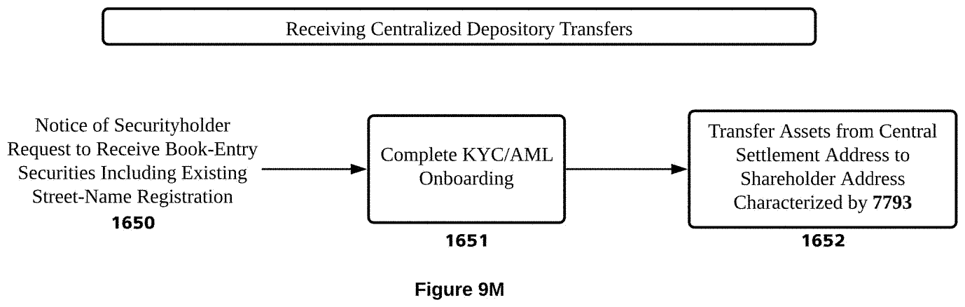

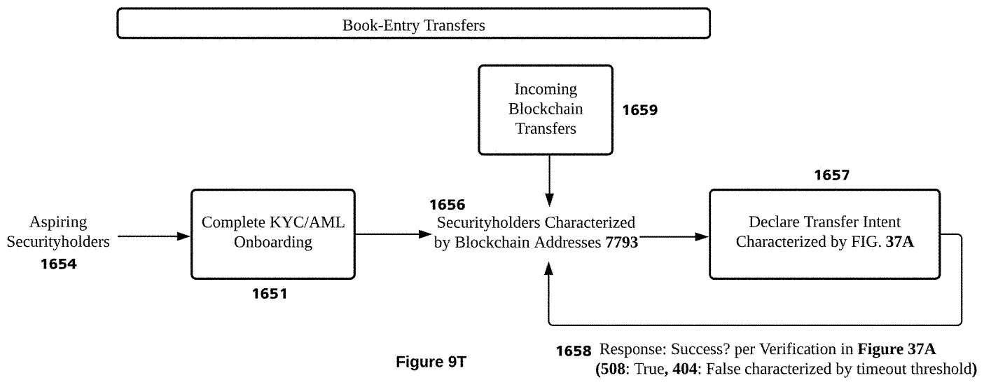

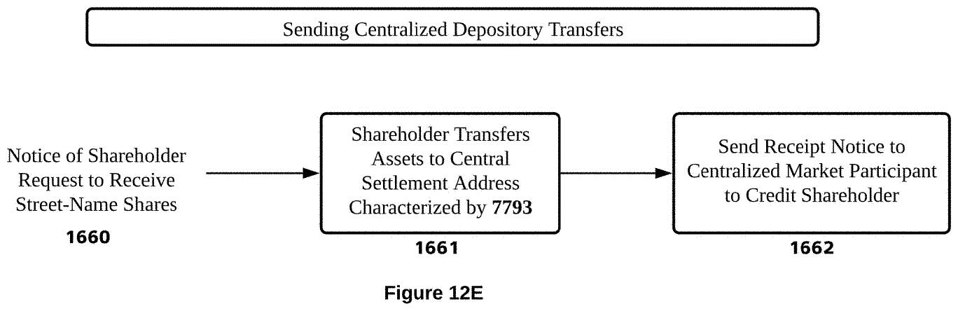

Although most of the systems and methods described herein to facilitate a blockchain transfer agent protocol execute automatically on a blockchain network 40, some ordinary tasks of a transfer agent effectively must be done through a manual central registered agent 1464 due largely to the centralized nature of Cede & Co. Thus, FIG. 12E describes the main process securityholders at a transfer agent implementing the present disclosure can simplistically go through to send centralized depository transfers. This system follows the logic of other processes for traditional transfer agents, wherein the improvement lies in that a blockchain address, including one set up and maintained by the transfer agent on behalf of Cede & Co. through a computing device leveraging namely a blockchain wallet, is used as the recordkeeping location for shares transferred from a securityholder address to Cede or equivalent abroad 1661, after which such market deposit participants involved including DTCC or a named broker-dealer are sent notice of the completed transfer, wherein the improvement lies that any interested party can audit the transfer not by querying the transfer agent 1464 but comprising direct observation on the blockchain including through a standardized block explorer 1662. A likewise process is enacted in reverse when receiving centralized depository transfers per FIG. 9M, the similar improvement comprising transfers directly on the blockchain including central depositories signing securities away from their blockchain address(es) to an onboarded book-entry securityholder 1656 or the transfer agent enacting such transfer through a central depository blockchain wallet held on behalf of such market participants.

All securities transfers require a form of register guarantee per SEC Rule 17Ad-15. Today, effectively all transfer agents comply with signature guarantees or equivalent abroad through medallion stamps which generally cost many hundreds of US dollars abroad in the instance of securityholders unable to access traditional banking infrastructure with their government-issued identification documents. This extremely high expense to transfer book-entry securities effectively disenfranchises billions of would-be securityholders from investing in a firm's issues when, in practice, average monthly investments for say an African family would account for a small fraction of the systematically centralized transfer fee.

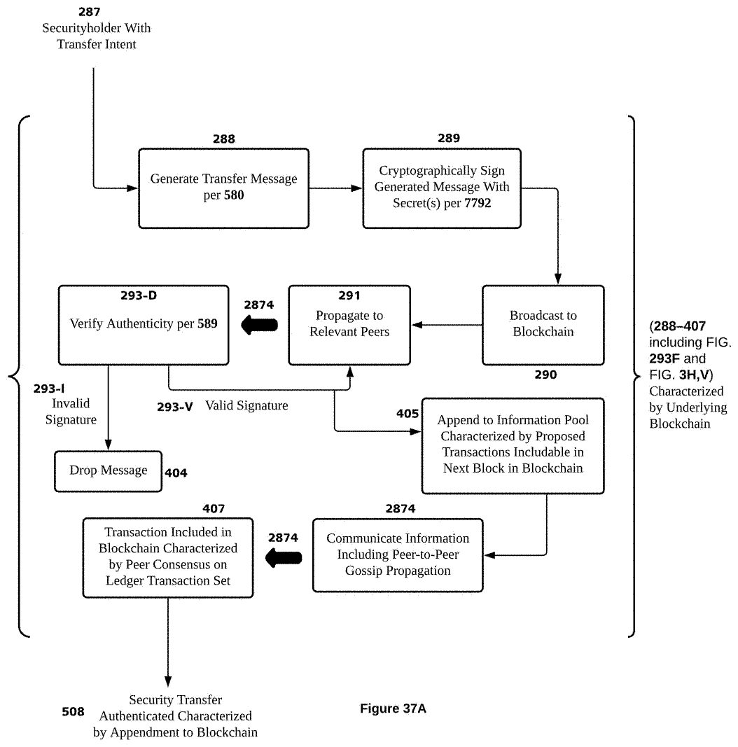

The present invention leverages double-entry bookkeeping verified by a blockchain network 40 characterized by its immutability to record issue ownership. Thus, individual parties can securely sign their own book-entry transfers of securities without a verifying central party. Furthermore, anyone can maintain shareholder records and thus asset ownership by querying the blockchain network 40 in question. With this ownership model, no party needs to be trusted for core transfer agent functionality so long as participants trust the underlying blockchain network 40. The only person who controls the transfer of a specified issue is the registrant on the books of 1464. This can be implemented in a regulatory-compliant way through federated database access and verification techniques on the part of 1464. However, the transfer guarantees per FIG. 37A themselves enable all of the blockchain-based transfer agent MSF recordkeeping.

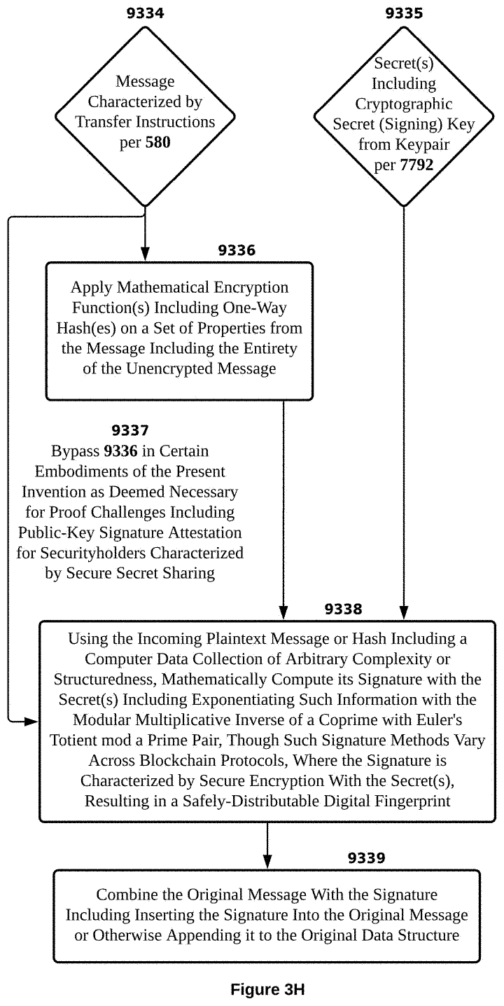

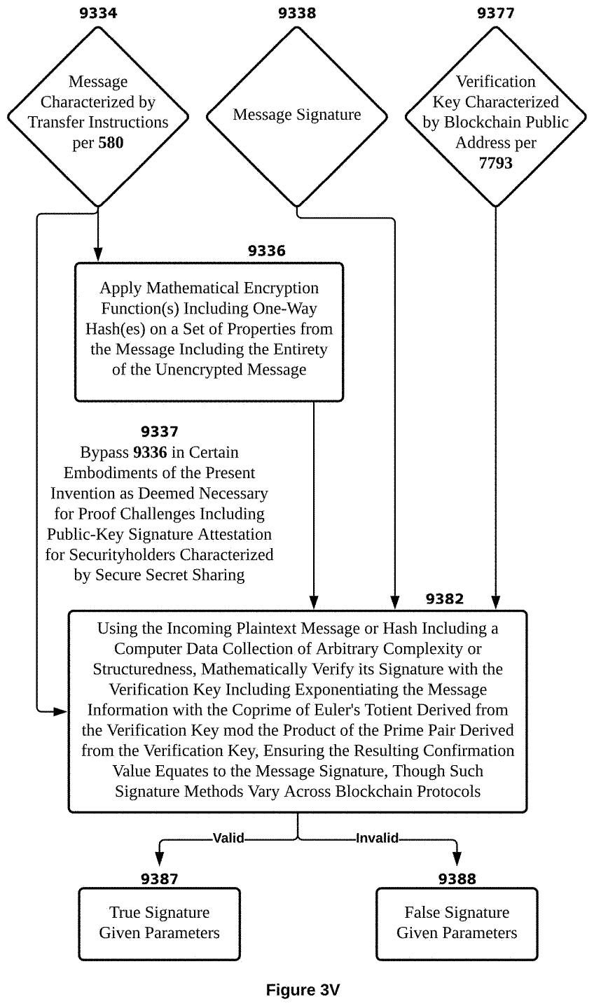

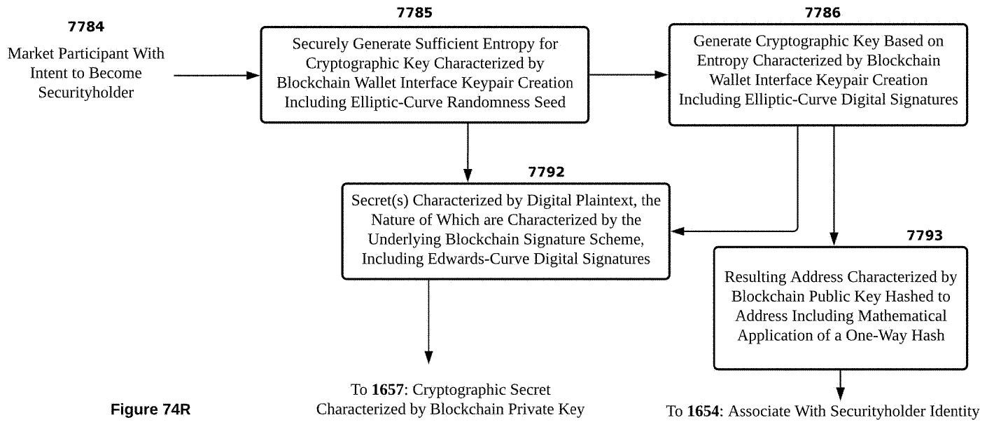

In stark contrast with the exorbitant traditional system of medallion stamps, the cryptographic transfer proofs characterized by disclosures in FIG. 3H, FIG. 3V, FIG. 74R, and FIG. 293F cost effectively nothing to perform on modern computing devices, yet such proofs provide security guarantees orders of magnitude greater when comparing medallion certificate historic forgery frequencies and theft rates of physical bank stamps to incidental disclosures of cryptographic secrets 7792.

Furthermore, leveraging a public blockchain ledger, including one characterized by a cryptographically-secure byzantine-fault tolerant consensus method, as the sole responsible party for the maintenance, transfer, and verification of shareholder ownership presents nearly boundless backup protection against catastrophic events. Namely, the failure of a few targeted central servers could wipe all local records of an MSF from traditional transfer agents, whereas every single node 846-5-10 including many independent backup nodes in the preferred embodiment partaking in the recordkeeping of a blockchain network 40 would need to go offline for such securityholder records to disappear, a scenario orders of magnitude less likely than the simultaneous failure of all centralized bookkeeping server computing devices. Furthermore, such presently disclosed protocol in its preferred embodiment including deployment on an established blockchain network 40 would be economically infeasible for any combination of malicious entities to perform a denial-of-service attack on, in stark contrast to traditional centralized transfer agent DRS request ports and portals which, due largely to systematic outdated infrastructure caused by lax competition and minimal use or public visibility, are in the opinion of the inventor susceptible to such attacks. Given security against adversaries, the presently-disclosed model of transfer agent ownership -representation drastically reduces operational complexities for core transfer agent services, and thus overall shareholder dollars wasted.

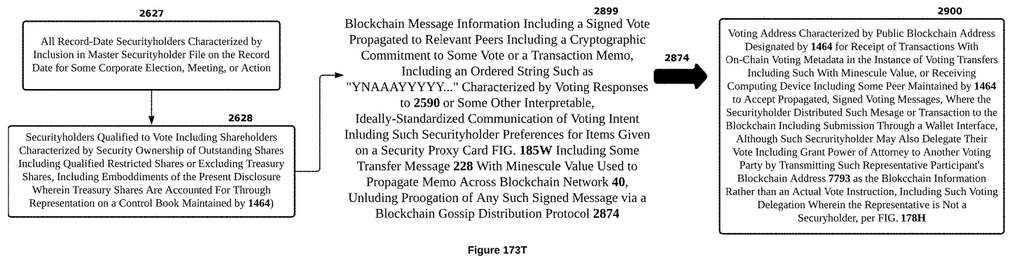

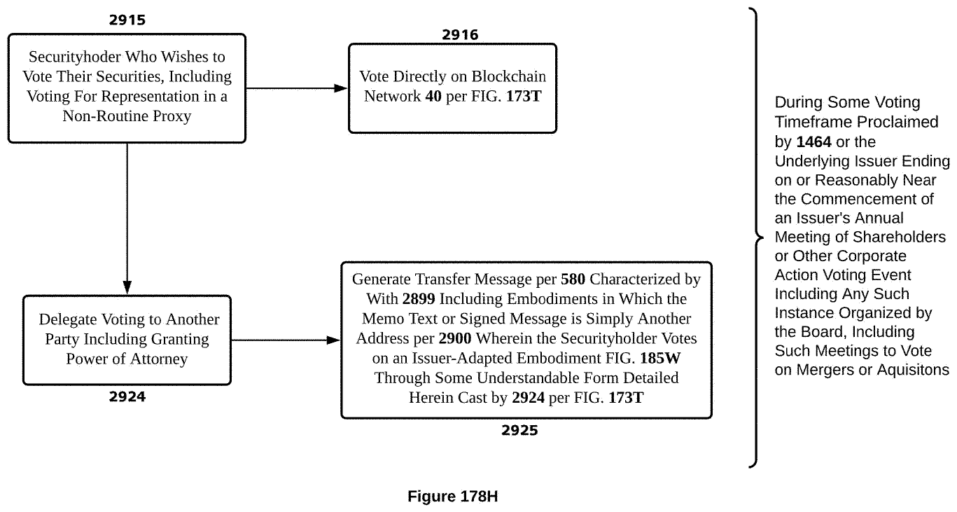

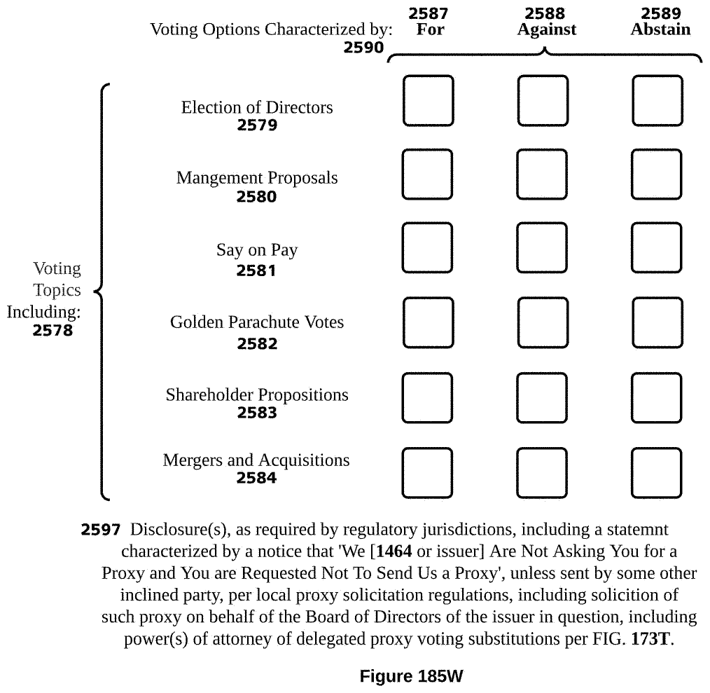

Lastly, the inventor presently discloses a novel way to tally shareholder votes comprising transfer memos or signed messages characterized by the underlying blockchain 40 and its signature schemes depicted in FIG. 74R. Per FIG. 173T, FIG. 178H, and FIG. 185W, a transfer agent 1464 can designate some voting address 2900 to which shareholders can submit voting messages detailed per 2899 or signed voting messages following similar schematics to some peer per FIG. 173T such that all book-entry votes are publicly countable yet safely anonymous so long as no securityholder reveals their address 7793, while votes are individually verifiable by the transfer agent 1464 or issuer. This requires the transfer agent 1464 to distribute region-specific regulatory notices including Notices of Internet Availability of Proxy Materials to all securityholders alongside instructions to cast blockchain votes 2899 after accessing properly-disclosed proxy materials including information statements, annual reports to securityholders, proxy card statements, etc.

This means institutional securityholder can comply with Section 14A(a) of the Exchange Act by simply revealing their public address 7793 when transaction memos are used in the preferred embodiment, namely via perpetual storage in some blockchain network 40 whilst signed votes in some implementations of the present disclosure require central storage of voting messages 2899. By this logic of transparent transfers, per 508, security holders can furthermore streamline audit or tax records and reporting since all asset ownership information is immutably public in accordance with a participant's address 7793 which can be revealed to the appropriate taxation authority or likewise compliantly disclosed by the transfer agent 1464.

1. A method for maintaining master securityholder files as a transfer agent including computing devices, the method comprising:
a computerized record of securityholder registration information characterized by SEC Rule 17Ad-9 including any other identifying information about securities and securityholders the transfer agent reasonably deems essential to its recordkeeping system for the efficient and effective research of record differences per (a)(8);
wherein some or all securityholder balances are not directly derived from the master securityholder file, but rather characterized by balances of digital assets represented on a blockchain network;

2. The method of claim 1, wherein registered securityholder identities are mapped to their stated or otherwise attested blockchain address.

3. The method of claim 1, wherein securityholders can transfer their assets directly on the blockchain including systems only enabling the transfer of fungible unrestricted securities.

4. The method of claim 1, wherein some or all outstanding security balances for transfer agent reports or standard verifications of securityholder balances including such balances claimed on the blockchain are derived or otherwise proven by querying the balance of a blockchain address.

5. The method of claim 2, wherein blockchain addresses are listed on the master securityholder file or other registrar records maintained by the transfer agent as permittable by applicable law.

6. The method of claim 3, wherein securityholders can only transfer securities to other market participants registered or otherwise verified with the transfer agent.

7. A system for securities transfer signature guarantees imposed by a transfer agent characterized by cryptographic proofs created by computing devices or used to validate securities transfers, the system comprising:
equitable access to computing processes including asymmetric cryptoeraphy systems or otherwise general public-key cryptographic systems for signing and verifying, proofs including such computer data encryptions pursuant to SEC Rule 17Ad-15;
wherein such proofs, characterized by cryptographic signatures, commitments, or otherwise encrypted messages including plaintext instructions processed through a cryptographic generation function can provably be assigned with negligible faults including collisions or non-deterministic behavior to a public-address signee, are respected as material truth by the transfer agent.

8. The system of claim 7, wherein such proofs execute on or otherwise propagate through a blockchain network including such a blockchain with historic digital storage of cryptographic transfer proofs characterized by directed acyclic graphs, Merkle Patricia tries, hashed Merkle roots, or other proofs including those based on asymmetric cryptography or one-way hashes.

9. The system of claim 7, wherein account ownership records on a blockchain including a distributed ledger can be independently verified with direct representation via such proofs.

10. The method of claim 1, wherein transfers are enforced through the system of claim 7.

11. The method of claim 1, wherein securityholders have complete access to their own account keypair and can independently sign transfers via the system of claim 7 which may be broadcast to a blockchain network to transfer securities in a way recognized by the transfer agent despite such transfer agent having no active role in the generation or signing of such transaction.

12. The system of claim 7, wherein any new market participant can create a keypair through a standard mathematical application of cryptographic randomness seeding which may then be represented as a mnemonic phrase including wallet import phrases maintained only by such peer, including the generation and encryption of such proofs completely offline prior any broadcasts.

14. A process for transfer-agent shareholder voting including representative participation in corporate governance, the process characterized by:
distribution of proxy materials or Notices of Internet Availability of Proxy Materials as required by applicable law including SEC Regulation 14A, SEC Regulation 14C, SEC Schedule 14A, and a plurality of SEC Rules defined thereof related to issuer disclosures and proper transfer-agent materials distributions and access-request requirements; and
publishing of such disclosed materials including proxy statements, information statements, or annual reports to securityholders at an accessible online public whereabouts which is in any other way compliant with SEC Rule 14a-16;
wherein the improvement comprises a digital voting process, the process comprising:
determining a shareholder's voting intention via observing a proxy card characterized in FIG. 185W and related proxy materials previously detailed;
encoding a shareholder's voting intention in a standardized format deemed by the transfer agent and further characterized FIG. 173T; and
generating a cryptographic commitment to a vote through a process characterized by FIG. 178H.

15. The process of claim 14, wherein such transactions containing memos or cryptographically-authenticated messages are broadcast over a blockchain network.

16. The process of claim 14, wherein such transaction messages containing memos or cryptographically-authenticated messages are sent directly to the transfer agent or reasonably related party including computing devices decreed as recipient addresses for sending such votes.

17. Systems of vote processing detailed in claim 14 which leverage the cryptographic transfer message guarantees detailed in claim 7.

18. The process of claim 14, wherein shareholders sign a transaction including the transfer of nominal value with additional information including transaction memo text or other encoded information communicating their voting intent characterized by the underlying blockchain.

19. The process of claim 14, wherein shareholders sign or encrypting a message containing the shareholder's voting intent using their secret information from their asymmetric keypair to be further processed by the transfer agent for proxy count collections.

20. The method of claim 1, wherein the record of securityholder information is not directly held by the transfer agent but rather stored or otherwise disclosed on the blockchain in an encrypted form with personal or otherwise regulatory information decodable on through a means accessible by said transfer agent leveraging their own cryptographic secrets to reveal such information.
